(19) United States
(12) Patent Application Publication
(10) Pub. No.: US 2016/0029440 A1
(43) Pub. Date: Jan. 28, 2016

(54) ROLL WITH INDUCTION HEATER, AND DEVICES AND METHODS FOR USING

(71) Applicant: 3 M INNOVATIVE PROPERTIES COMPANY, Saint Paul, MN (US)

(72) Inventors: Samuel Kidane, Cupertino, CA (US); Karl K. Stensvad, Inver Grove Heights, MN (US); Randy S. Bay, Woodbury, MN (US)

(73) Assignee: 3 M INNOVATIVE PROPERTIES COMPANY, Saint Paul, MN (US)

(21) Appl. No.: 14/775,242

(22) PCT Filed: Mar. 5, 2014
(86) PCT No.: PCT/US14/20787

§ 371 Date: Sep. 11, 2015

Related U.S. Application Data
(60) Provisional application No. 61/778,756, filed on Mar. 13, 2013.

(51) Int. Cl. H05B 6/10; B30B 15/34

(52) U.S. Cl. CPC H05B 6/102; H05B 6/107; B30B 15/34

(57) ABSTRACT

A roll with an inductively-heatable layer and with an induction heater disposed within an interior space of the roll so that the induction heater does not move with the rotation of the roll; and, devices and methods for using such a roll.

### BACKGROUND

Thermally controlled rolls have often found use in thermal treating of substrates. Such rolls are conventionally heated or cooled as a unit, e.g. by circulating a heat-exchange fluid throughout the interior of the roll.

### SUMMARY

In broad summary, herein is disclosed a roll comprising an inductively-heatable layer and with an induction heater disposed within an interior space of the roll so that the induction heater does not move with the rotation of the roll; and, devices and methods for using such a roll. These and other aspects of the invention will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a side schematic cross sectional view of an exemplary roll as disclosed herein.

FIG. 2 is a side schematic cross sectional view of an exemplary roll of the type disclosed in FIG. 1, disposed with a second roll so as to form a nip.

FIG. 3 is a photograph of a polyester web before being thermally treated.

FIG. 4 is a photograph of the polyester web of FIG. 3, after being thermally treated to be de-bagged.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, bottom”, “upper”, lower”, “under”, “over”, “front”, “back”, “outward”, “inward”, “up” and “down”, and “first” and “second” may be used in this disclosure, it should be understood that those terms are used in their relative sense only unless otherwise noted.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

### DETAILED DESCRIPTION

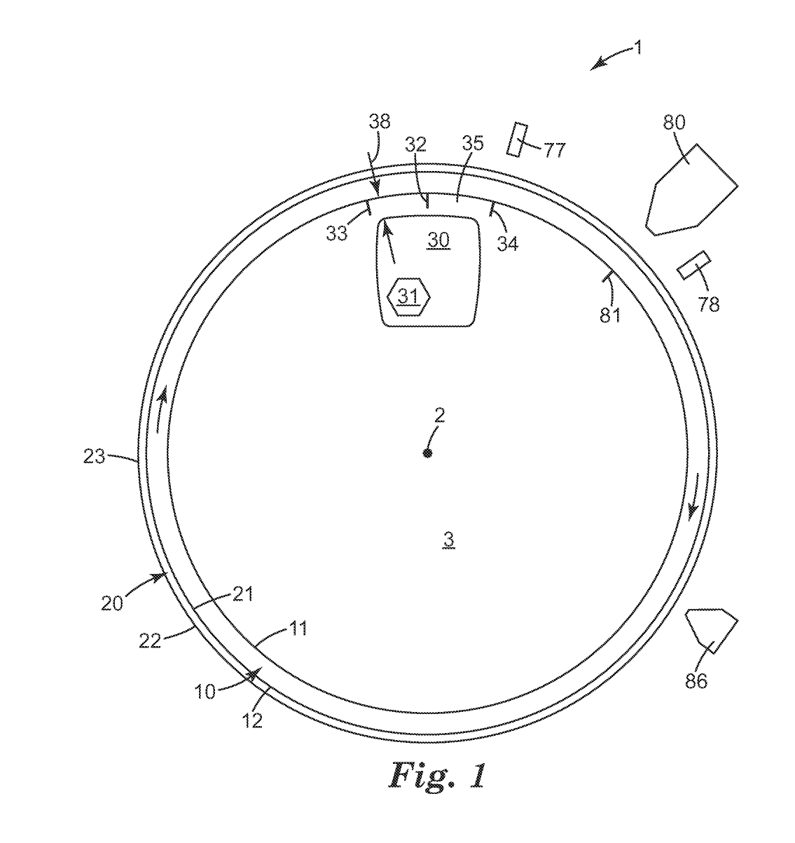

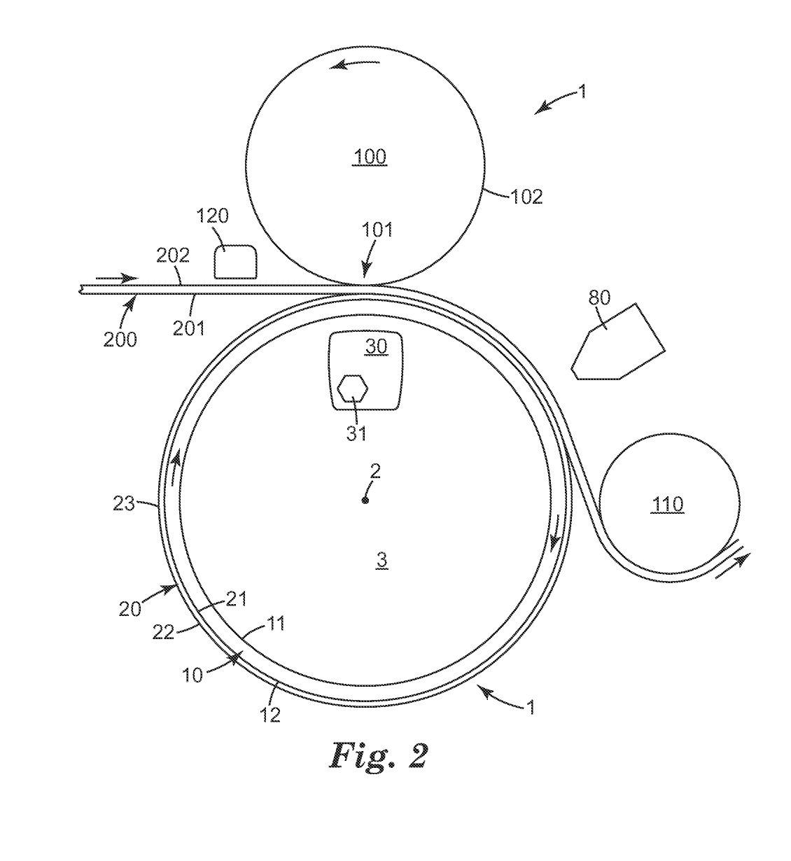

Reference is made to FIGS. 1-2 in order to illustrate exemplary embodiments of the disclosures presented herein. Shown in FIG. 1 in generic representation is a roll 1 (depicted in side schematic cross-sectional view from a perspective aligned with the axis of rotation 2 of the roll) that may be used e.g. for thermal processing of substrates. Roll 1 is a hollow, cylindrical roll that is rotatable about axis of rotation 2 so as to have a rotation path (indicated by the curved arrows in FIG. 1), that comprises a radially-outwardmost surface 23, and that comprises an interior space 3 within hollow cylindrical roll 1.

As used herein, the term radially-outward refers to a direction away from the axis of rotation 2 of roll 1; radially-inward refers to a direction toward axis of rotation 2. The term transversely refers to a direction aligned with axis of rotation 2 (which axis of rotation will typically be aligned with the long (cylindrical) axis of roll 1). Such a transverse direction will often correspond to a crossweb direction of a substrate that may be thermally processed by being contacted with roll 1 as explained later herein. Terms such angular, angular direction, and the like, refer to directions aligned with the rotation path of roll 1, with the term rearward meaning in the direction of the rotation of roll 1 (as indicated by the curved arrows in FIG. 1), and with the term frontward meaning against the direction of the rotation of roll 1. For example, as depicted in FIG. 1, angular position 81 is angularly rearward of angular position 34, and angular position 33 is angularly frontward of position 34.

Roll 1 comprises a hollow cylindrical support shell 10 with a radially-inward-facing surface 11 and a radially-outward-facing surface 12. Roll 1 further comprises an inductively-heatable annular (cylindrical) layer 20 that is positioned radially outward of support shell 10 and is supported thereby. It will be appreciated that support shell 10 (and annular layer 20) will reside in the rotation path of roll 1. Inductively-heatable annular layer 20 may be conveniently provided around the entire angular (circumferential) extent of support shell 10/roll 1, and in various embodiments may be e.g. generally, substantially, or strictly continuous around this angular extent. However, annular layer 20 need only extend across whatever transverse extent of roll 1 is desired to be inductively heated (by way of a specific example, roll 1 might have a transverse width of e.g. 1 meter, but with annular layer 20 being present only e.g. over a transversely-centered 0.8 meter of that width, which arrangement may be suitable for thermally processing any substrate with a transverse (crossweb) width of about 0.8 meter or less). In some embodiments annular layer 20 may be present in a macroscopic pattern (even if annular layer 20 is e.g. locally continuous). For example, annular layer 20 may be provided as circumferentially-extending or transversely-extending stripes, or in a checkerboard pattern or in any other macroscopic pattern, whether regular or irregular.

Inductively-heatable annular layer 20 comprises a radially-inward-facing surface 21 and a radially-outward-facing surface 22. In some embodiments radially-inward-facing surface 21 of layer 20 may be in direct contact with radially-outward-facing surface 12 of support shell 10; however, in other embodiments one or more additional layers (e.g., a tie layer, a thermally insulating layer, an electrically insulating layer, etc.) may be present between annular layer 20 and support shell 10. Inductively-heatable annular layer 20 is in conductive thermal communication with radially-outwardmost surface 23 of roll 1. In many embodiments, this may be provided by having radially-outward-facing surface 22 of annular layer 20 serve as the radially-outwardmost surface 23 of roll 1 (as shown in exemplary embodiment in FIG. 1). In other embodiments, one or more additional annular layers may be provided radially outward from inductively-heatable annular layer 20, with the outwardmost surface of the outwardmost layer serving as outwardmost surface 23 of roll 1. Such an additional layer or layers may be provided for any purpose (e.g., for enhanced strength, abrasion resistance, release properties, and so on), as long as the required conductive thermal communication between inductively-heatable annular layer 20 and outwardmost surface 23 of roll 1 is maintained. This may be achieved e.g. by providing that such an additional layer or layers are relatively thin and/or that they possess a relatively high thermal conductivity. In various embodiments, any such additional layer may exhibit a thermal conductivity of at least about 10, 20, 50, 100, 200, or 400 W/m-° K (these and all such thermal conductivities referred to herein may be measured at 20° C. by any suitable method). In various embodiments, any such additional layer may comprise a radial thickness of no more than about 100, 50, 20, 10, 5, 2, 1, 0.5, or 0.1 μm.

An induction heater 30 (shown in generic representation in FIG. 1) is provided within the interior space 3 of hollow cylindrical roll 1 (that is, within the interior of hollow cylindrical support shell 10). Induction heater 30 is positioned radially inwardly adjacent to an angular portion of the rotation path of roll 1 (i.e., angular portion 35 that is bounded by angular positions 33 and 34, as discussed in detail later herein); and, induction heater 30 is fixedly attached to a heater mount 31 (shown in generic representation) so that induction heater 30 does not rotate along with roll 1. That is, induction heater 30 is positioned radially inward of radially-inward-facing surface 11 of support shell 10, with a suitable distance of closest approach provided therebetween (as indicated by distance 38 in FIG. 1). With induction heater 30 held stationary as roll 1 rotates, successive angular sections of roll 1 will pass through angular portion 35 of the rotation path of roll 1, thus causing the inductively-heatable layer 20 in each section to be successively heated by heater 30. (It will be understood that no physical boundary or delimiter may necessarily exist between any such angular “sections” of roll 1; the concept of angular sections is used merely for ease of description).

In this manner, the radially-outwardmost surface 23 of each angular section of roll 1 can be increased to a desired temperature as that section passes through angular heating zone 35, to advantageous effect. For example, a substrate that is desired to be thermally processed can be brought into contact with radially-outwardmost surface 23 of roll 1, at a location near or within angular heating zone 35, in order that the substrate (or at least a surface of the substrate that contacts roll surface 23) may be heated, as discussed in detail later herein. This may be done without necessitating that the entirety of roll 1 (e.g., support shell 10, and any other supports, structural members, braces, etc. that may be provided within roll 1) be heated as a unit to such a temperature. This may be advantageous e.g. in minimizing energy costs. It may also allow the temperature of heating zone 35 to be more rapidly adjusted (e.g. in response to a change in the temperature of an incoming substrate) than would be possible with a conventional roll that is temperature-controlled as a unit and that consequently may have a large amount of thermal inertia. Other advantages may be gained as well, as discussed later herein.

Annular layer 20 may comprise any suitable composition that is inductively heatable to a sufficient extent to perform in a desired use. In many embodiments, annular layer 20 may comprise a composition that is very efficient at being inductively heated (so as to minimize energy costs); however, this is not necessarily required. It is well known that inductive heating can arise from resistive (ohmic) heating derived from eddy currents in a material with a suitable balance of electrical conductivity/resistivity, or from magnetic hysteresis in a material of suitable magnetic properties (e.g., ferromagnetic materials), or often, from a combination of both mechanisms. Thus, in various embodiments annular layer 20 may be comprised of a material (e.g. a metal) that possesses suitable electrical conductivity/resistivity properties, that possesses suitable magnetic properties, or both. In terms of electrical properties, any material with a suitable balance of conductivity/resistivity may be used, although materials (e.g., nickel, iron, steel and so on) with electrical resistivity in a range that gives rise to increased heating may sometimes be preferred over metals (e.g., copper, aluminum, and so on) that have such low resistivity that they may be less efficient at being resistively heated. In various specific embodiments, inductively-heatable annular layer 20 may comprise an electrical resistivity of less than 1×10⁻⁴ ohm-meter, or less than about 1×10⁻⁷ ohm-meter. In further embodiments, annular layer 20 may comprise an electrical resistivity greater than 1×10⁻⁸ ohm-meter (these and all such electrical resistivities referred to herein may be measured at 20° C. by any suitable method).

In terms of magnetic properties, such properties of a material may be characterized e.g. in terms of relative permeability μ/μₒ; that is, the magnetic permeability of the material divided by the magnetic permeability of free space. In various embodiments, inductively-heatable annular layer 20 may comprise a relative permeability of at least 1.05, 1.1, 10, 20, 40, 80, 160, 200, 1000, 2000, 5000, or more. (Magnetic permeability being variable with frequency and strength of the applied magnetic field, a frequency of 100 kHz and a field strength of 0.002 Tesla may be used as a standard reference condition for all such magnetic permeabilities and relative permeabilities mentioned herein). There may not be any particular upper limit to the relative permeability; rather, such considerations may rather depend on whether a material is available at reasonable cost. In various embodiments, annular layer 20 may comprise a relative permeability of at most 1000000, 80000, 10000, or 2000. It is emphasized that, electrical conductivity/resistivity and magnetic permeability being separate properties, the overlap between materials that are suitable for use as inductively-heatable annular layer 20 because of their electrically resistive properties, and those that are suitable for use because of their magnetic permeability, may not necessarily be exact. That is, a material might have e.g. a relative permeability that does not necessarily render it an attractive candidate for inductive heating, but it might still be suitable for such use because of its balance of electrical conductivity/resistivity (and vice-versa).

It will be appreciated that an advantageous aspect of the present disclosures is the ability to locally heat a section of annular layer 20 without the heat being unacceptably dissipated by being thermally conducted away into an adjacent area of annular layer 20 (whether such an area is angularly adjacent, or transversely adjacent, to the heated section). Such an issue may be addressed e.g. by choice of the thermal conductivity of the material of annular layer 20. Thus, in various embodiments, annular layer 20 may comprise a thermal conductivity of at most about 1000, 500, 150, 100, or 50 W/m-° K. In further embodiments, annular layer 20 may comprise a thermal conductivity of at least about 1, 5, 10, 15, or 25 W/m-° K.

The tendency of a local section of annular layer 20 to lose heat by conduction into an adjacent area of annular layer 20 may also be addressed by choice of the radial thickness of annular layer 20. (Such a radial thickness may also affect the extensive-property heat capacity of layer 20, which may affect the ability to quickly heat layer 20, independently of the issue of thermal conductivity.) Accordingly, a suitable radial thickness of annular layer 20 may be chosen in order to facilitate rapid local heating, and to minimize the loss of such heat by conduction to adjacent areas of layer 20. In various embodiments, annular layer 20 may comprise a radial thickness of at most about 500, 200, 100, 40, 20, or 10 μm. In further embodiments, annular layer 20 may comprise a radial thickness of at least about 0.5, 1.0, 2.0, 5.0, 10, or 20 μm.

Any material that is amenable to inductive heating may be used to form annular layer 20. For example, many metals, metal oxides, etc. may be suitable for this purpose. In particular, metals such as nickel (with a relative permeability that may range over e.g. 100-600, and/or with an electrical resistivity that may be in the range of e.g. 7×10⁻⁸ ohm-meter), and iron or steel (with a relative permeability that may be e.g. 100 or more, and/or with an electrical resistivity that may range from e.g. 1×10⁻⁷ to 7×10⁻⁷ ohm-meter), may be attractive candidates. (It will be appreciated that some steels may be very useful by way of having high relative permeabilities, while other steels may be relatively non-magnetic but may still have a balance of electrical resistivity/conductivity that renders them useful). And, certain alloys of e.g. nickel with iron or steel may display very high relative permeabilities and thus may be advantageous. It is understood that these are merely non-limiting examples and that any material that can exhibit acceptable inductive heating may be used. In particular, it is noted that while materials such as nickel and the like may have certain properties that may be advantageous in some respects, other materials (e.g., aluminum, copper, and the like), may also be satisfactorily inductively heatable (as noted in the Examples herein). Thus in general, any suitable metal, metal alloy, metal oxide, and so on, may be used as long as it performs acceptably. The choice of the material(s) of layer 20 may be made in concert with the choice of induction heater used therewith.

The material of layer 20 may be provided radially outside of support shell 10 in any suitable manner. In some embodiments, the material may be deposited directly onto outwardmost surface 12 of shell 10 by any suitable method (e.g., by physical vapor deposition, magnetron sputtering, plasma deposition, ion-implantation, laser cladding, laser surface alloying, electric arc spraying, chemical vapor deposition, ion-plating, electro-deposition, or electroless deposition, noting that there may not always be bright-line boundaries between some of these methods). Such deposition may also be performed by any type of liquid-based coating process (e.g., by coating a suspension of inductively-heatable particles onto shell 10, and then removing the liquid). Or, the particles could be suspended in a material that is coated onto surface 12 and then is dried, agglomerated, crosslinked, cured, etc. to form a matrix comprising the inductive particles. It is understood that such a coating of inductively-heatable particles may fall into the earlier-presented concept of e.g. a generally or substantially continuous coating, as long as the particles are present in sufficiently high concentration to provide a layer 20 that is inductively heatable to a sufficient extent and with sufficient uniformity. (Of course, the particles may need to possess particular properties, e.g. size, composition etc., to be adequately inductively heatable).

In some embodiments, one or more annular layers may be provided between surface 12 of support shell 10 and annular layer 20. For example, a tie layer or seed layer (of any suitable composition) may be provided that may bond well to surface 12 of shell 10, and that may provide an enhanced bonding surface for layer 20, may enhance the ability of the material of layer 20 to be deposited thereon, and so on. One or more layers might be provided for some other purpose (in addition to, or instead of, such a tie layer), as discussed later herein.

In some embodiments, annular layer 20 may be provided as a thin foil (of e.g. metal) that is wrapped around the radially outwardmost surface of support shell 10 and is attached thereto. Such attachment may be performed by any suitable method, e.g. by the use of a layer of adhesive or the like, by shrink-fitting the foil onto shell 10, and so on. It will be appreciated that the use of such a foil will provide annular layer 20 as a strictly continuous layer, i.e. one in which the material is present as a microscopically continuous matrix rather than being collectively provided by discrete particles that are not necessarily connected to each other. It will be appreciated that many deposition methods (e.g., sputter-coating, electroless deposition, etc.), even though they may deposit the material in the form of fine bodies, atoms, etc., will lead to agglomeration and/or coalescence of such fine bodies with the result that such methods also lead to the formation of a strictly continuous layer.

Support shell 10 supports annular layer 20 (e.g., so that layer 20 is not unacceptably damaged or destroyed when exposed to the pressure of a backing roll used to form a nip against roll 1, as discussed later in detail). Thus, the radial thickness of shell 10 may desirably be held in a range that provides sufficient strength, but in which the radial thickness of shell 10 does not cause induction heater 30 to be positioned so far away (radially inward) from annular layer 20 that acceptable heating of annular layer 20 may not be achieved. In various embodiments, the radial thickness of support shell 10 (from radially-inward-facing surface 11 to radially-outward-facing surface 12) may be at most about 8, 4, 2, 1, or 0.5 cm. In further embodiments, the radial thickness of support shell 10 may be at least about 1, 2, 4, 10, or 20 mm. In various embodiments the ratio of the radial thickness of support shell 10 to the radial thickness of inductively heatable annular layer 20 may be at least about 4, 8, 20, 40, 200, 400, 800, 2000, or 4000.

In at least some embodiments, support shell 10 is not significantly inductively heatable, in comparison to annular layer 20. This means that a support shell 10, when passed through an angular inductive-heating zone as described herein in the same manner as an inductively-heatable annular layer 20 that is supported by such a support shell 10, exhibits a temperature rise that is no more than 10% of the rise experienced by layer 20 (e.g., so that an inductive heating process that causes an annular layer 20 to rise from a temperature of 100° C. to a temperature of 150° C. would cause support shell 10 to rise from 100° C. to no more than 105° C.). It will be appreciated that experiments to determine whether a candidate support shell material is not significantly inductively heatable, may need to be performed in such manner as to not be affected by e.g. conductive transfer of heat into the support shell 10 from inductively-heatable layer 20. Thus, for example, such an experiment could be run with a “blank” support shell 10 that does not comprise an inductively-heatable layer 20 thereupon.

In various embodiments, support shell 10 may comprise a relative permeability of less than about 1.05, 1.01, or 1.005. In various embodiments, support shell 10 may comprise an electrical resistivity of greater than 10⁻⁴, 10³, or 10¹⁰ ohm-meter.

Still further, it may be advantageous that support shell 10 comprise a relatively low thermal conductivity, e.g. so that the amount of heat that is conductively lost from annular layer 20 into support shell 10 may be minimized. Thus, in some embodiments support shell 10 may exhibit a thermal conductivity of at most about 50, 30, 20, 10, 5, 2, 1, or 0.5 W/m-° K. It will be understood, however, that even if a support shell 10 is at least somewhat inductively heatable, and/or it comprises a relatively high thermal conductivity, in some embodiments it may be possible to provide an annular thermal insulating layer between support shell 10 and inductively-heatable layer 20 so as to adequately thermally isolate layer 20 from support shell 10. In other embodiments, no layer of any material is present between support shell 10 and annular layer 20.

As mentioned, it may be advantageous that support shell be comprised of a relatively strong and/or rigid material, particularly when roll 1 is used as part of a nip and thus may encounter relatively high nip pressures. Thus, in various embodiments, support shell may be comprised of a material that possesses a flexural modulus of at least about 2, 4, 8, or 16 GPA, as measured e.g. at 20° C. by customary methods. (It will be appreciated that while 20° C. may be a convenient temperature e.g. for comparison of potentially suitable support shell materials, any such material will of course need to maintain its flexural strength (and, indeed, its overall mechanical integrity) at the actual temperatures at which it is used in the process disclosed herein).

Furthermore, it may be advantageous that the coefficient of thermal expansion of support shell 10 and that of annular layer 20 be fairly similar; and/or, it may be advantageous that the coefficient of thermal expansion of shell 10 and layer 20 each may be relatively low (e.g., to minimize any differential stresses at the interface between the two, due to differences in expansion upon heating of). Thus, in various embodiments, the coefficient of linear thermal expansion of the material of support shell 10 may be within plus or minus 40, 20, 10, or 5% of the coefficient of linear thermal expansion of the material of annular layer 20 (with both measured at 20° C. by customary methods). In specific embodiments, the coefficient of linear thermal expansion (in fractional change in length per degree of temperature change) of annular layer 20 may be at most about 40, 20, 15, 10, or 5 (10⁻⁶/° C.); and, the coefficient of linear thermal expansion of support shell 10 may be at most about 40, 20, 15, 10, or 5 (10⁻⁶/° C.).

Support shell 10 may be made of any suitable material. Such materials may include e.g. ceramic materials, organic polymer materials, etc., and may be reinforced or strengthened (e.g., with one or more fibrous fillers, particulate fillers, etc.) as needed for a given application. For example, alumina (which is available with excellent strength and rigidity, and which in various grades may exhibit a thermal conductivity of e.g. about 30 W/m-° K), may be suitable. Materials that are based on inorganic-reinforced polymeric materials may be particularly suitable. For example, the fiberglass-reinforced epoxy material available from e.g. McMaster-Carr under the trade designation G11 (with a thermal conductivity in the range of about 0.29 W/m-° K, a flexural modulus in the range of 18-20 GPA, and a Rockwell Hardness in the range of about M110-M115), has been found to work well.

In some embodiments, roll 1 may contain a relatively compliant layer (e.g., between support shell 10 and annular layer 20). Such a layer might be made of any suitable resilient polymeric material, e.g. rubber or the like. However, in alternative embodiments, roll 1 will not comprise any annular layer any material that comprises a Shore A hardness of less than about 70. In many embodiments, radially-inward-facing surface 11 of support shell 10 may be the radially inwardmost surface of roll 1. However, if desired, one or more annular layers might be provided inwardly of support shell 10, for any purpose (as long as they do not unacceptably interfere with the ability to inductively heat layer 20).

Support shell 10 may comprise any convenient diameter; the lower limit of such a diameter may only be limited by the ability to insert induction heater 30 into the interior space inside support shell 10. In various embodiments, support shell 10 may comprise an interior diameter (ID) of at least about 10, 20, 30, or 40 cm. In further embodiments, support shell 10 may comprise an interior diameter of at most about 80, 40, or 20 cm. In the case of a very large-diameter support shell, two (or more) induction heaters may be angularly adjacently positioned (e.g., side by side) along the angular heating zone to perform in concert. (An additional induction heater(s) may also be provided at some other angular location within support shell 10, if it is desired to provide one or more additional angular heating zones). Support shell 10 may comprise any convenient width; such a width may be picked e.g. in view of the width of a substrate that is desired to be thermally processed. In the case of very wide substrates, two (or more) induction heaters may be adjacently positioned along the transverse width of the angular heating zone (e.g., end to end) to provide the ability to inductively heat a desired width of annular layer 20.

A shown e.g. in FIG. 1, support shell 10 may be provided as a hollow cylindrical shell bearing inductively-heatable annular layer 20 radially outward thereof. Such a cylindrical shell 10 may be supported by any suitable members or the like (including e.g. endcaps that may be provided at one or both ends of the shell), as long as such support members do not interfere with the ability to rotate shell 10/roll 1 while keeping induction heater 30 stationary. Such a cylindrical shell may be rotatably supported by any suitable arrangement of bearings or the like that allow such rotation (and may be driven to rotate by any suitable mechanism, whether direct-drive or through some mechanical linkage). In some embodiments, such support members and bearings will possess sufficient strength to allow roll 1 to be used as part of a nip as described herein. By definition, such support members and bearings do not encompass e.g. air bearings of the type that are only suitable to withstand relatively low pressures (e.g., pressures not commensurate with a nip). As has been discussed, in certain embodiments other layers (e.g., thermally insulating layers, release layers, etc.) might be present on or within roll 1. However, in other embodiments, inductively-heatable layer 20 and support shell 10 may be the only major annular layers of roll 1 (disregarding any ancillary, non-annular components such as support members, bearings, endcaps, and so on). In further embodiments the only major annular components of roll 1 may be support shell 10, inductively-heatable layer 20, and a tie layer therebetween. Furthermore, roll 1 as disclosed herein will be distinguished (e.g., as using a hollow cylindrical support shell 10) from any apparatus in which induction heaters are used in combination with belts, platens, injection molds, non-rotating fixtures and workpieces, or the like.

Induction heater 30 may be any suitable design as long as it can perform the desired function. It may be particularly useful for heater 30 to have a long axis that can be aligned with the long (transverse axis) of roll 1 (that is, the axis of rotation of roll 1), in order that a relatively uniform electromagnetic field can be established along the entire transverse width of roll 1 over which conductive heating is desired to be achieved. Heater 30 is attached to a heater mount 31 (with heater 30 and mount 31 both shown in generic representation in FIG. 1) within interior space 3 of roll 1 so that heater 30 does not move with the rotation of roll 1 (noting that this condition does not preclude the position of heater 30 from being adjustable within interior space 3). Induction heater 30 may be powered, controlled, etc., by any suitable equipment, which may be located inside or outside of interior space 3 of roll 1 (often, some components of such equipment may be located inside interior space 3, while other components may be outside).

Induction heater 30 is positioned radially inwardly adjacent to an angular portion 35 of the rotation path of roll 1, as shown in FIG. 1. Angular portion 35 is defined as lying between frontward angular position 33 and rearward angular position 34, as shown in FIG. 1. Positions 33 and 34 may be conveniently defined as those positions angularly frontwards and rearwards along the rotation path of roll 1, in which the electromagnetic field emanating from heater 30 has dropped to 5% or less of the peak value of the electromagnetic field (such a peak value may often be at or near the angular centerpoint 32 of angular portion 35). For convenience, angular portion 35 to which heater 30 is adjacent will be referred to herein as an angular heating zone and angular positions 33 and 34 will be respectively referred to as the front and rear angular edges of heating zone 35.

By an angular portion (and zone) is meant a portion/zone that extends less than 180 degrees around the rotation path of roll 1. In various embodiments, the angular extent of angular heating zone 35 (as defined by edges 33 and 34), may be at most about 45, 30, or 20 degrees. In further embodiments, the angular extent of angular heating zone 35 may be at least about 5, 10, or 20 degrees. In various embodiments, heater 30 may be positioned so that the distance of closest approach between any portion of heater 30 and radially inwardmost major surface 11 of support shell 10 (or of any layer that is provided radially inwardly of support shell 10), is less than about 20, 10, 4, or 2 mm (an exemplary distance of closest approach is indicated by reference number 38 in FIG. 1). Induction heater 30 can operate at any suitable frequency, which frequency may be picked to best match the particular material used for inductively-heatable layer 20. Induction heater 30 may be e.g. water-cooled (in addition to any of the other temperature-control provisions discussed herein, e.g. cooling of the interior space within support shell 10).

In at least some embodiments, a cooling device may be provided radially outward from annular layer 20 of roll 1, at any suitable location rearwardly along the rotation path of roll 1 from angular heating zone 35. Such a cooling device 80 is shown in exemplary generic representation in FIG. 1. In some embodiments, cooling device 80 may be a surface-cooling device, meaning that it removes heat from the radially outwardmost surface 23 of roll 1 and/or from a radially outwardmost surface of a substrate that is in contact with outwardmost surface 23 of roll 1. In some embodiments, such a surface-cooling device may take the form of a cooling roll (e.g., a metal roll or belt that is passively or actively cooled to a desired temperature range) that is in contact with surface 23 of roll 1 or with the surface of a substrate thereon. In other embodiments, such a surface-cooling device may direct a moving heat-transfer fluid (whether liquid or gas) at least generally radially inward toward radially outwardmost surface 23 of roll 1. For example, such a cooling device might comprise an air nozzle (often called an air knife), that may direct air (or any suitable gas or gas mixture) toward surface 23 of roll 1. Such a moving fluid might be e.g. ambient air, or might be air or some other fluid that is cooled (or heated) to a desired temperature range.

It will be appreciated that the use of such a cooling device can provide that an angular section of annular layer 20 that has passed through angular heating zone 35, can then be immediately cooled. This may enable advantageous processing of various substrates, as discussed later herein. Thus, the position of such a cooling device 80 may be chosen to enhance such effect. Specifically, the position of cooling device 80 (as designated by its centerpoint 81) may be relatively angularly close to angular heating zone 35. In various embodiments cooling device 80 may be placed no more than about 180, 120, 60, 45, 30, or 15 degrees angularly rearward (along the rotation path of roll 1) from the centerpoint 32 of angular heating zone 35. In further embodiments, cooling device 80 may be placed at least about 5, 10, or 20 degrees angularly rearward from centerpoint 32.

It will be appreciated that (in addition to the location of cooling device 80 along the rotation path), an angle at which device 80 impinges a cooling fluid onto radially-outwardmost surface 23 of roll 1 (or onto the surface of a substrate thereon) may be advantageously controlled. In the exemplary embodiment of FIG. 1, cooling device 80 is configured to direct fluid generally straight toward surface 23 (i.e., at or near a 90 degree angle to surface 23 at the location of impingement). However, if desired, in some embodiments cooling device 80 could be angled so as to impinge the fluid toward surface 23 at a rearward glancing angle (i.e., angled away from heating zone 35). This may provide that the cooling fluid does not impinge onto roll 1 or a substrate thereon, at or near heating zone 35. In alternative embodiments, cooling device 80 could be angled so as to impinge the fluid toward surface 23 at a frontward glancing angle (i.e., angled toward heating zone 35). This may provide that the temperature at least at or near rearward angular position 34 of heating zone 35, may be controlled by the collective effects of both induction heater 30 and cooling device 80 (similar effects may also of course be achieved by locating cooling device 80 very close to rearward angular position 34 of heating zone 35, as mentioned above).

It will be appreciated that cooling device 80 may be placed so as to cool a substrate that is in contact with roll 1; or, it may be placed so as to cool roll 1 after such a substrate has been removed from roll 1. If desired, one or more auxiliary cooling devices (e.g., device 86 as shown in generic representation in FIG. 1) may be provided further rearwardly along the rotation path of roll 1 from cooling device 80. Such an auxiliary cooling device may help e.g. provide that each angular section of annular layer 20 has reached a relatively stable or uniform temperature before that section completes a circuit of the rotation path and arrives back at heating zone 35. If desired, the interior space 3 defined within hollow cylindrical roll 1 may be actively temperature controlled, e.g. heated or cooled to a desired range (whether by way of a heating/cooling device provided therein, or by way of an externally heated or cooled fluid that is introduced into interior space 3). Such arrangements may e g enhance the ability to maintain induction heater 30 at a relatively constant temperature (noting also that induction heater 30 may have its own cooling capability as mentioned). It is further noted that interior space 3 may be, but does not have to be, a sealed space (e.g. by way of providing an endcap at one or both ends of roll 1).

If desired, one or more temperature sensors may be provided for use with roll 1. Such sensors may be used to monitor the temperature of radially outermost surface 23 of roll 1, and/or to monitor the temperature of a substrate that roll 1 is used to thermally treat, as desired. Any number of such sensors may be used (two such sensors are shown in FIG. 1; sensor 77 which monitors the temperature near rear angular edge 34 of angular heating zone 35, and sensor 78 which monitors the temperature near surface-cooling unit 80). Any suitable sensor, operating by any suitable mechanism, may be used, although e.g. infrared temperature sensors may be particularly convenient. If desired, such temperature sensors may be used to provide closed-loop control of inductive heater 30 and/or surface-cooling unit 80, e.g. with the temperature readings from the sensors used to adjust the power input to heater 30.

Roll 1 as disclosed herein can be used to perform thermal processing of a substrate, e.g. with savings in energy costs as compared to the use of a conventional roll in which the temperature of the entire roll is controlled as a unit. In some embodiments, roll 1 may be used in combination with a second roll 100, as shown in exemplary embodiment in FIG. 2. Second roll 100 may be placed radially adjacent to roll 1 (which will now be referred to for convenience as a first roll) e.g. with the long axes (and axes of rotation) of the two rolls being parallel to each other in a well-known manner, so that at the point of closest approach of the rolls to each other, a nip 101 is formed as shown in exemplary manner in FIG. 2. (The concept of a nip is well-known to the ordinary artisan, as a relatively narrow gap between two rolls through which a substrate may be passed during the processing of the substrate, with pressure being applied to the substrate by the two rolls.) The distance of closest approach between the two rolls (i.e., between outer surface 102 of second roll 100, and radially-outwardmost surface 23 of first roll 1) at nip 101 may be set to any desired value, based e.g. on the thickness of the substrate to be processed. In various embodiments such a distance may be at least about 2, 5, 10, 20, 40, 80, 160, 200, 400, or 800 microns. In further embodiments, such a distance may be at most about 8, 4, 2, or 1 mm. (It will be appreciated that in many cases, the rolls may merely be pressed toward each other, with the distance of closest approach between the two rolls being set e.g. by the thickness of the substrate rather than being governed by any specific setting applied to the rolls themselves.)

Nip 101 may be located at any position along the angular extent of heating zone 35, e.g. toward or at heating zone front edge 33, or toward or at heating zone rear edge 34. In some embodiments, nip 101 may be generally, substantially or exactly centered on centerpoint 32 of heating zone 35. In other embodiments, nip 101 may be positioned near rear edge 34 of heating zone 35. A nip may often be idealized as having very little circumferential extent (e.g., 1 mm or less) along the rotation path of roll 1. However, it will be appreciated that in many cases (particularly if e.g. second roll 100 is relatively compliant (e.g., is a rubber-surfaced roll or the like) and the rolls are pressed together at relatively high pressure), nip 101 might have a circumferential extent of e.g. 2, 4, or even 8 mm or more.

In embodiments in which such rolls are pressed toward each other to provide a nip force, it may be advantageous for support shell 10 of first roll 1 to possess the ability to survive such nip forces. The force with which such rolls are pressed toward each other is conventionally expressed in pounds per linear inch (pli) or N/cm. In various embodiments, second roll 100 and first roll 1 may be pressed toward each other to provide a nip force of at least 2, 4, 10, 50, 100, 200, or 400 phi (respectively, 3.5, 7, 18, 88, 175, 350, or 700 N/cm). In further embodiments, second roll 100 and first roll 1 may be pressed toward each other to provide a nip force that is no more than about 8000, 4000, 2000, 1000, or 600 pli (respectively, 14000, 7000, 3500, 1750, or 1000 N/cm). The temperature of second roll 100 may be controlled if desired. In some embodiments, second roll 100 may be actively thermally controlled to a roll setpoint. By this is meant that the entirety of roll 100 is controlled as a unit (e.g. by the circulation within roll 100 of a heating or cooling fluid supplied from an external device) to a desired temperature range (setpoint). In other embodiments, second roll 100 may comprise a hollow cylindrical support shell with an inductively-heatable annular layer 20 that is positioned radially outward of the support shell and is supported thereby, and an induction heater positioned within the interior space of the hollow second roll and mounted so as to not move with the rotation of the second roll. In other words, second roll 100 may be a roll of the same general type as roll 1, although the two rolls do not have to be identical in design (nor would they have to be controlled to the same temperature profile). In some embodiments a take-off roll 110 may be provided that may assist in removing a substrate from roll 1, as shown in FIG. 2 (noting that such a take-off roll may be used whether or not a second roll 100 is used along with roll 1 to form a nip). Although not shown in FIG. 2, one or more auxiliary cooling devices may be provided at any location along the rotation path of roll 1 (e.g., either before or after a substrate is removed from contact with surface 23 of roll 1).

The processing of a substrate 200 (in an exemplary device comprising a nip 101) is depicted in generic representation in FIG. 2. Substrate 200 will often comprise a longitudinal (downweb) axis and a transverse (crossweb) axis, and will comprise a thickness that is much less than either the downweb or crossweb dimension. (In FIG. 2, substrate 200 is shown entering nip 101 in a generally horizontal orientation; however, any orientation including vertical may be used.) First major surface 201 of substrate 200 is brought into intimate thermal contact with radially-outwardmost surface 23 of roll 1 so that, in a given section of substrate 200, thermal energy is conductively transferred from surface 23 of roll 1 into at least the surface 201 of substrate 200 as that section of substrate 200 passes through angular heating zone 35. The initial contact of substrate 200 with roll 1 may occur anywhere within angular heating zone 35 (e.g. generally, substantially, or exactly at nip 101, as shown in FIG. 2) if desired. However, it is also possible that such initial contact may occur at a point frontward from heating zone 35 along the rotation path of roll 1. Thus in various embodiments, the initial contact point of substrate 200 with surface 23 of roll 1 may occur less than about 180, 90, 45, 20, 10, or 5 degrees angularly frontward from centerpoint 32 of angular heating zone 35. (Often, upon the contacting of substrate 200 with surface 23, substrate 200 will move along an arcuate path with surface 23 at substantially or exactly at the same speed as surface 23).

As substrate 200 enters nip 101, second major surface 202 of substrate 200 will contact outer surface 102 of second roll 100. After passing through nip 101 (e.g. as it approaches the rearward angular edge 34 of heating zone 35, or after it passes rearward edge 34) substrate 200 may be separated from roll 1. In some embodiments, it may be desired to maintain substrate 200 in intimate thermal contact with roll 1 for a desired rearward wrap angle (e.g., to ensure that the substrate has adequately cooled), before substrate 200 is separated from contact with roll 1. In various embodiments, such a rearward wrap angle (with centerpoint 32 of angular heating zone 35 as a reference point) may be at least about 25, 45, 90, 120, or 180 degrees (an exemplary wrap angle of about 85 degrees is shown in FIG. 2). In further embodiments, such a rearward wrap angle may be at most about 270, 180, 120, or 90 degrees. In some embodiments, substrate 200 may be wrapped at least partly around second roll 100 rather than around first roll 1; in such cases, the only contact of substrate 200 with first roll 1 may be in nip 101. Roll 1 and any device comprising roll 1 (e.g. any device additionally including a backing roll and/or a takeoff roll, and/or supply rolls, idler rolls, tension control rolls, etc.) may be operated at any suitable line speed, e.g. 0.1, 0.5, 1, 5, 10, 20, 40, 80, 200, or 400 meters per minute or more.

The rolls, devices and methods disclosed herein can allow successive sections of substrate 200 (along the long axis of the substrate), or at least a portion of the cross-sectional thickness of such sections, to be heated to a desired temperature range, as each successive section moves through angular heating zone 35. Such methods and devices can provide that, if desired, the substrate passes through a nip 101 that is provided within the heating zone (so that such a nip can e.g. press substrate 200 against surface 23 of roll 1 e.g. to enhance the thermal contact between the two, and/or can achieve some other desired effect). Such methods and devices can also provide that after exiting angular heating zone 35, substrate 200 (or at least major surface 202 thereof), may be cooled with a surface-cooling device 80 (e.g., while substrate 200 is still in intimate thermal contact with roll 1.) This may provide that substrate 200 (or at least a portion of the cross-sectional thickness thereof) may be cooled, e.g. very rapidly cooled, from the temperature to which it was brought in passing through heating zone 35. It will be appreciated that e.g. the minimizing of the thermal conductivity of layer 20 and/or of the thermal mass of layer 20 (e.g., as determined at least partly by the radial thickness of layer 20), and/or the provision that e.g. support shell 10 of roll 1 have a low thermal conductivity and/or be separated from annular layer 20 by a thermally insulating layer, may enhance this ability. In various embodiments, the difference between the temperature to which surface 23 of roll 1 is heated in angular heating zone 35, and the temperature to which surface 23 of roll 1 is cooled by angularly-rearward device 80, may be at least about 10, 20, 40, or 80° C. Similarly, in various embodiments, the difference between the temperature to which at least a surface of substrate 200 is heated in angular heating zone 35, and the temperature to which at least a surface of substrate 200 is cooled by device 80, may be at least about 10, 20, 40, or 80° C.

If desired, an auxiliary heating and/or cooling device 120 may be used to preheat or precool substrate 200 before it contacts roll 1, as shown in exemplary embodiment in FIG. 2. Such a device 120 may be placed on either major side of substrate 200, and may be any kind of device, e.g. a preheating or precooling roll, a unit that directs a moving heat-transfer fluid onto substrate 200, an infrared heater, and so on. In some embodiments, device 120 may be used to perform preheating (or precooling), e.g. to enhance the uniformity with which substrate 200 is brought to a desired temperature before while passing through heating zone 35. In some embodiments, device 120 may be used to perform precooling (e.g. if it is desired to raise substrate 200 from a very cold temperature to a relatively hot temperature) substrate 200 or at least a surface and/or cross-sectional portion thereof. In a variation of such approaches, second roll 100 might be held at a relatively cold temperature, while induction heater 30 is used to heat annular layer 20 to a relatively hot temperature, if it is desired to expose the different major surfaces of substrate 200 to very different temperatures in passing through the nip.

The roll, devices and methods disclosed herein may be used to perform thermal treatment of any desired substrate of any desired composition. For example, in some embodiments substrate 200 may be an existing film (e.g., a polymeric film that is unwound from a supply roll). In other embodiments, substrate 200 may comprise an at least semi-molten material, e.g. a molten extrudate that has not yet been solidified into an existing film. (Such an extrudate may be thermoplastic or thermoset, as desired.) Whether an existing film or an extrudate, substrate 200 may comprise a single layer, or multiple layers. Substrate 200 may be of any desired thickness, and in various embodiments may comprise a thickness of at least about 10, 20, 40, 80, 200, 400, or 800 microns. In further embodiments, substrate 200 may comprise a thickness of at most about 4, 2, 1, 0.5, 0.2, or 0.1 mm. Substrate 200 may be a dense film or may comprise porosity. Substrate 200 may comprise any desired filler (e.g., mineral filler, etc.) and may comprise any desired additive (e.g., impact-modifier, plasticizer, anti-oxidant, and so on).

The roll, devices and methods disclosed herein may be used to perform any desired thermal treatment for any desired purpose. Among the thermal treatment processes that the disclosed roll and/or devices might be used for include e.g. annealing, de-wrinkling, modification of crystallinity, removing or diminishing of porosity, and the like. In some embodiments, such thermal treatment may be designed to treat the entire cross-sectional thickness of substrate 200. In other embodiments, such thermal treatment may be designed to treat only a major surface and/or a portion immediately adjacent thereto (e.g. while leaving the opposing major surface and/or a portion immediately adjacent thereto, relatively untreated).

In representative examples, thermal treatment might be designed to modify the crystallinity of a major surface of a substrate, to cause an additive to bloom preferentially toward a surface, to heat and then quench a surface (and possibly a cross-sectionally adjacent portion), to promote thermal degradation of a surface (e.g. to render the surface more bondable), to change the release characteristics of a surface, to change the optical properties (e.g., reflectivity or gloss) of a surface, and so on.

In some embodiments, substrate 200 may be a multilayer film. For example, such treatment might be used to modify (or to destroy or remove) a heat-sensitive surface layer of a film, to modify the crystallinity of a layer of a film, and so on. In some embodiments, the methods and devices disclosed herein might be used to laminate substrate 200 to a second substrate (with nip 101 thus serving as a lamination nip). In some embodiments, the methods and devices might be used to perform imaging (e.g., by heating a developer or toner layer to fix the layer).

### LIST OF EXEMPLARY EMBODIMENTS

### Embodiment 1

A device comprising: a hollow cylindrical roll that is rotatable about an axis of rotation so as to have a rotation path, and that comprises an interior space within the hollow cylindrical roll; an induction heater that is provided within the interior space of the hollow cylindrical roll and that is positioned radially inwardly adjacent to an angular portion of the rotation path of the hollow cylindrical roll and that is fixedly attached to a heater mount so that the induction heater does not rotate with the hollow cylindrical roll; wherein the hollow cylindrical roll comprises a hollow cylindrical support shell; and, an inductively-heatable annular layer that is positioned radially outward of the support shell and is supported thereby and that is in conductive thermal communication with a radially outwardmost surface of the hollow cylindrical roll.

### Embodiment 2

The device of embodiment 1 wherein the inductively-heatable annular layer comprises a radial thickness of from 1 μm to about 500 μm.

### Embodiment 3

The device of embodiment 1 wherein the inductively-heatable annular layer comprises a radial thickness of from about 2 μm to about 50 μm.

### Embodiment 4

The device of embodiment 1 wherein the inductively-heatable annular layer comprises a radial thickness of from about 5 μm to about 20 μm.

### Embodiment 5

The device of any of embodiments 1-4 wherein the inductively-heatable annular layer comprises a relative permeability of from about 1.1 to about 1000000.

### Embodiment 6

The device of any of embodiments 1-4 wherein the inductively-heatable annular layer comprises a relative permeability of from about 10 to about 80000.

### Embodiment 7

The device of any of embodiments 1-4 wherein the inductively-heatable annular layer comprises a relative permeability of from about 20 to about 10000.

### Embodiment 8

The device of any of embodiments 1-4 wherein the inductively-heatable annular layer comprises a relative permeability of from about 80 to about 1000.

### Embodiment 9

The device of any of embodiments 1-8 wherein the inductively-heatable annular layer comprises an electrical resistivity of less than about 10⁻⁴ ohm-meter.

### Embodiment 10

The device of any of embodiments 1-8 wherein the inductively-heatable annular layer comprises an electrical resistivity of less than about 10⁻⁷ ohm-meter.

### Embodiment 11

The device of any of embodiments 1-10 wherein the inductively-heatable annular layer comprises a thermal conductivity of from about 10 to about 500 W/m-° K.

### Embodiment 12

The device of any of embodiments 1-10 wherein the inductively-heatable annular layer comprises a thermal conductivity of from about 15 to about 150 W/m-° K.

### Embodiment 13

The device of any of embodiments 1-12 wherein the inductively-heatable annular layer comprises a metal layer chosen from the group comprising nickel, iron, steel, and alloys thereof.

### Embodiment 14

The device of any of embodiments 1-13 wherein the hollow cylindrical support shell comprises a radial thickness of from about 1 mm to about 4 cm.

### Embodiment 15

The device of any of embodiments 1-13 wherein the hollow cylindrical support shell comprises a radial thickness of from about 1 mm to about 2 cm.

### Embodiment 16

The device of any of embodiments 1-13 wherein the hollow cylindrical support shell comprises a radial thickness of from about 2 mm to about 1 cm.

### Embodiment 17

The device of any of embodiments 1-16 wherein the hollow cylindrical support shell comprises a relative permeability of less than about 1.05.

### Embodiment 18

The device of any of embodiments 1-17 wherein the hollow cylindrical support shell comprises an electrical resistivity of greater than 10⁻⁴ ohm-meter.

### Embodiment 19

The device of any of embodiments 1-17 wherein the hollow cylindrical support shell comprises an electrical resistivity of greater than 10³ ohm-meter.

### Embodiment 20

The device of any of embodiments 1-17 wherein the hollow cylindrical support shell comprises an electrical resistivity of greater than 10¹⁰ ohm-meter.

### Embodiment 21

The device of any of embodiments 1-20 wherein the hollow cylindrical support shell comprises a thermal conductivity of from about 30 to about 0.05 W/m-° K.

### Embodiment 22

The device of any of embodiments 1-20 wherein the hollow cylindrical support shell comprises a thermal conductivity of from about 10 to about 0.05 W/m-° K.

### Embodiment 23

The device of any of embodiments 1-20 wherein the hollow cylindrical support shell comprises a thermal conductivity of from about 1 to about 0.05 W/m-° K.

### Embodiment 24

The device of any of embodiments 1-23 wherein the coefficient of thermal expansion of the hollow cylindrical support shell is within plus or minus 50% of the thermal expansion coefficient of the inductively-heatable annular layer.

### Embodiment 25

The device of any of embodiments 1-23 wherein the coefficient of thermal expansion of the hollow cylindrical support shell is within plus or minus 20% of the thermal expansion coefficient of the inductively-heatable annular layer.

### Embodiment 26

The device of any of embodiments 1-25 further comprising a surface-cooling device that is positioned radially outward of the hollow cylindrical roll at a location that is rearwardly along the rotation path of the hollow cylindrical roll, which surface-cooling device is configured to direct a moving heat-transfer fluid generally radially inward toward the radially outwardmost surface of the hollow cylindrical roll.

### Embodiment 27

The device of any of embodiments 1-26 wherein the induction heater is positioned so that the point of closest approach between at least a portion of the induction heater and a radially inwardmost major surface of the hollow cylindrical support shell, is less than about 10 mm.

### Embodiment 28

The device of any of embodiments 1-27 wherein the interior space defined within the hollow cylindrical roll is an actively cooled space.

### Embodiment 29

A device for thermally processing a substrate, comprising; a first, hollow cylindrical roll that is rotatable about an axis of rotation so as to have a rotation path, and that defines an interior space within the first roll; an induction heater that is provided within the interior space of the first roll and that is positioned radially inwardly adjacent to an angular portion of the rotation path of the first roll and that is fixedly attached to a heater mount so that the induction heater does not rotate with the first roll; wherein the first roll comprises a hollow cylindrical support and an inductively-heatable annular layer that is positioned radially outward of the support shell and is supported thereby and that is in conductive thermal communication with a radially outwardmost surface of the first roll; and, a second roll that is positioned radially outwardly adjacent the first roll with the first and second rolls being pressed towards each other so as to form a nip therebetween, the nip being provided within the angular portion of the rotation path to which the induction heater is radially adjacent.

### Embodiment 30

The device of embodiment 29 wherein the first roll and the second roll are pressed towards each other to provide a nip pressure of about 2 pounds per linear inch to about 4000 pounds per linear inch.

### Embodiment 31

The device of embodiment 29 wherein the first roll and the second roll are pressed towards each other to provide a nip pressure of about 10 pounds per linear inch to about 1000 pounds per linear inch.

### Embodiment 32

The device of embodiment 29 wherein the first roll and the second roll are pressed towards each other to provide a nip pressure of about 100 pounds per linear inch to about 1000 pounds per linear inch.

### Embodiment 33

The device of any of embodiments 1-32 wherein the hollow cylindrical support shell is comprised of a material that exhibits a flexural modulus of at least about 2 GPA.

### Embodiment 34

The device of any of embodiments 1-32 wherein the hollow cylindrical support shell is comprised of a material that exhibits a flexural modulus of at least about 10 GPA.

### Embodiment 35

The device any of embodiments 1-34 wherein the first roll does not comprise any annular layer of material that comprises a Shore A hardness of less than about 70.

### Embodiment 36

The device of any of embodiments 1-35 wherein the angular portion of the rotation path of the first roll to which the induction heater is positioned radially adjacent, occupies an angular arc along the rotation path of from about 5 degrees to about 45 degrees.

### Embodiment 37

The device of any of embodiments 1-35 wherein the angular portion of the rotation path of the first roll to which the induction heater is positioned radially adjacent, occupies an angular arc along the rotation path of from about 10 degrees to about 30 degrees.

### Embodiment 38

The device of any of embodiments 1-37 further comprising a surface-cooling device that is positioned radially outward of the first roll so as to provide a cooling zone at a location that is rearwardly along the rotation path of the first roll from the angular portion of the rotation path of the first roll to which the induction heater is positioned radially adjacent.

### Embodiment 39

The device of embodiment 38 wherein an angular centerpoint of the cooling zone is located from about 25 degrees to about 120 degrees rearwardly along the rotation path of the first roll, from an angular centerpoint of the angular heating zone.

### Embodiment 40

The device of any of embodiments 38-39 wherein the surface-cooling device is configured to impinge a moving heat-transfer fluid on the radially outwardmost surface of the first roll or an a major surface of a moving substrate that is in contact with, and moving with, the radially outwardmost surface of the first roll.

### Embodiment 41

The device of any of embodiments 29-40 wherein the second roll is actively thermally controlled to a roll setpoint.

### Embodiment 42

A method of thermally processing a substrate, the method comprising; contacting a first major surface of the substrate with a radially outwardmost surface of a hollow cylindrical roll that is rotatable about an axis of rotation so as to have a rotation path, and that defines an interior space within the hollow cylindrical roll, wherein an induction heater is provided within the interior space of the hollow cylindrical roll and is fixedly attached to a heater mount so that the induction heater does not rotate with the hollow cylindrical roll and is positioned radially inwardly adjacent to an angular portion of the rotation path of the hollow cylindrical roll so as to provide an angular heating zone of the hollow cylindrical roll, wherein the hollow cylindrical roll comprises a hollow cylindrical support shell and an inductively-heatable layer that is positioned radially outward of the hollow cylindrical support shell and is supported thereby, and that is in conductive thermal communication with the radially outwardmost surface of the hollow cylindrical roll; operating the induction heater so that the inductively-heatable layer of the hollow cylindrical roll is inductively heated as it passes through the angular heating zone along the rotation path of the hollow cylindrical roll, and, moving the substrate along the rotation path of the hollow cylindrical roll through the angular heating zone with the substrate in contact with the radially outwardmost surface of the hollow cylindrical roll, so that the substrate is conductively heated by the radially outer surface of the hollow cylindrical roll as the moving substrate passes through the angular heating zone.

### Embodiment 43

The method of embodiment 42, further comprising the step of surface-cooling the substrate by the use of with a surface-cooling device that is positioned radially outward of the first roll so as to provide a cooling zone at a location that is rearwardly along the rotation path of the first roll from the angular heating zone.

### Embodiment 44

The method of any of embodiments 42-43 wherein the substrate comprises a solid film.

### Embodiment 45

The method of any of embodiments 42-43 wherein the substrate comprises a molten extrudate.

### Embodiment 46

The method of any of embodiments 42-45 wherein the inductive heating causes a particular section of the first major surface of the first roll to be heated to a first temperature as the particular section passes through the angular heating zone; and, wherein the surface-cooling causes the particular section to be cooled, as the particular section passes through the cooling zone, to a second temperature that is more than 20° C. below the first temperature.

### Embodiment 47

The method of any of embodiments 42-46 wherein the substrate is not significantly inductively heated by the induction heater.

### Embodiment 48

The method of any of embodiments 42-47 wherein the hollow cylindrical roll is a first roll and wherein a second roll is provided radially outwardly adjacent the hollow cylindrical first roll with the first and second rolls being pressed towards each other so as to form the nip therebetween, the nip being provided within the angular heating zone of the first roll, and wherein the method comprises moving the substrate into the nip between a first roll and a second roll so as to contact a first major surface of the substrate with the radially outwardmost surface of the first roll and to contact a second major surface of the substrate with a radially outwardmost surface of the second roll.

### Embodiment 49

The method of any of embodiments 42-48, wherein the method is performed using the device of any of embodiments 1-41.

### EXAMPLES

### Representative Example

An inductively-heatable thermal-treating roll was produced of a generally similar design to that shown in FIG. 1, by the following procedure: a hollow cylindrical support shell was obtained from Accurate Plastics (Yonkers, N.Y.) that was comprised of a fiberglass-reinforced epoxy resin, available under the trade designation G11. The radial dimensions of the support shell were approximately 14.30 cm ID and 15.24 cm OD (thus providing a radial shell-wall thickness of approximately 0.47 cm). The transverse length (i.e., along the rotation axis) of the shell was approximately 57.15 cm. A thin layer (believed to be in the range of a few nm) of silver was deposited on the outermost radial surface of the shell, after which a layer of nickel was plated thereon by electroless deposition. The nickel layer was medium phosphor (estimated to be in the range 5-9% phosphorus) and was estimated to be in the range of approximately 10 micrometers radial thickness. This inductively-heatable layer was put onto the entire transverse length of the support shell except for a border portion (of approximately 1-2 cm) at each transverse end of the shell.

The shell was supported so that it could be rotated about its rotation axis. A custom induction heating head was obtained from AjaxTocco (Warren, Ohio) and was installed inside the hollow interior space of the shell, fixedly attached to a heater mount so that the heating head remained stationary as the hollow shell rotated. The induction heating head had an elongate length of approximately 51 cm, and was installed with the long axis of the heating head parallel to the axis of rotation of the hollow shell. The radially outwardmost surface of the heating head was positioned approximately 5 mm away from the radially inwardmost surface of the shell. The heating head was centered at the approximate transverse center of the support shell. A 5/10 kW, 10 to 50 kHz, TOCCOtron AC solid state air-cooled, 220/480 Volt, 1/3 Phase, 50/60 Hz power supply unit (available from AjaxTocco) was used to supply power to the induction heating head.

The thus-produced thermal-treating roll was similar to the exemplary design of FIG. 1, except that the induction heating head was located in the vertically lowermost portion of the interior of the shell, instead of the vertically uppermost portion shown in FIG. 1 (that is, the heater was at an approximately 6 o'clock position rather than an approximately 12 o'clock position as is shown in FIG. 1).

An air knife was positioned radially outward of the roll, at approximately at 1 o'clock position. Thus, the air knife was positioned approximately 150 degrees angularly rearward (counterclockwise in this view) along the rotation path of the roll from the centerpoint of the angular heating zone supplied by the induction heating head. The nozzle of the air knife was positioned approximately 3 mm from the outwardmost surface of the roll, was positioned so as to direct air directly toward the roll surface (i.e., at an angle of approximately 90 degrees), and had an elongate length of approximately 45.72 cm with the long axis of the air knife being oriented along the transverse direction of the roll. The air knife was a ‘Super Air Knife’ model air knife available from EXAIR (Cincinnati, Ohio), and was supplied by compressed building air at ambient temperature (e.g., approximately 22° C.) and at a pressure of approximately 0.62 MPa.

A takeoff roll was installed radially outward of the hollow shell, at an approximately 11 o'clock position. An input (steering) roll was installed radially outward of the hollow shell, at an approximately 10 o'clock position. This arrangement allowed a substrate (e.g., an existing film) to be passed over the steering roll so as to contact the surface of the thermal-treating roll at approximately an 8 o'clock position, to then travel with the roll (moving counterclockwise as described) to the angular heating zone provided by the inductive heating head, to pass through the angular heating zone and then to pass through the cooling zone provided by the air knife, and then to break contact with the thermal-treating roll at approximately the 12 o'clock position. (A nip was not used in this arrangement). The overall wrap angle, from first contact of the substrate with the thermal-treating roll to breakaway of the substrate from the thermal-treating roll, was approximately 210 degrees.

The above-described arrangement was used to thermally treat (anneal and de-bag) an approximately 50 μm thick polyester (PET) film. The polyester film was in roll form, was approximately 26.67 cm wide, and had an approximately 13.33 cm wide center portion that was baggy (as could be easily seen by visual inspection). The baggy polyester web had been deliberately created by tightly winding the polyester web into a roll with a narrow shim web inserted near the crossweb center of the polyester web and storing the roll in an oven overnight at a somewhat elevated temperature, which resulted in the center portion of the polyester web being slightly stretched to impart bagginess to that portion of the polyester web.

The polyester film was taken from an unwind, passed over the steering roll and onto the thermal-treating roll, passed through the heating and cooling zones while in contact with the thermal-treating roll, and removed from the thermal-treating roll by the take-off roll, using the arrangement described above. The line speed was approximately 61 cm per minute.

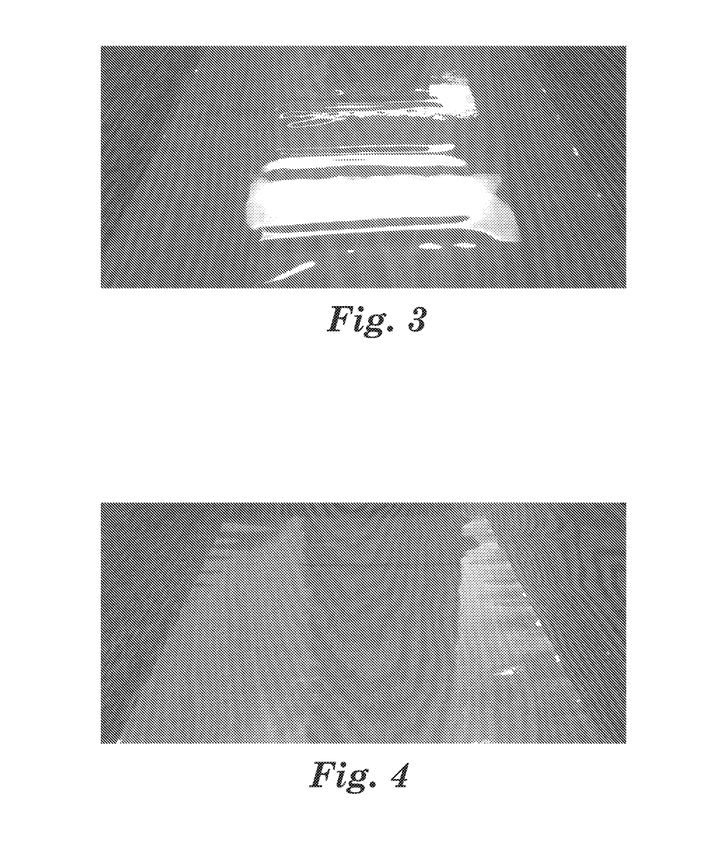

The power supplied to the induction heater was controlled so that the polyester film, in passing through the angular heating zone, was taken to a temperature in the range of approximately 85° C. or greater (that is, at least at or somewhat above the glass transition temperature of PET). (In some representative experiments, the TOCCOtron power supply was operated at a setting of approximately 111 amps (rms), 227 volts (rms), and a frequency of approximately 16.5 kHz). The airflow to the air knife was controlled so that the film had typically cooled to approximately 50° C. by the time it broke contact with the thermal-treating roll. This thermal treatment was able to successfully de-bag the polyester film, as evidenced by comparison of FIG. 3 (original baggy film) to FIG. 4 (de-bagged film). (In FIGS. 3 and 4, the irregular light and dark striations are from the surface of the table that the film was resting on, and should be disregarded.)

### OTHER EXAMPLES

Experiments were also performed using a support shell in the form of a hollow alumina shell (of generally similar dimension to the above-described G11 shell, with the alumina comprising a thermal conductivity of approximately 30 W/m-° K) bearing a molybdenum-manganese inductively-heatable layer (of approximately 35-40 μm radial thickness) thereupon. Other experiments were done using a support shell in the form of a hollow cardboard shell (of approximately 15.2 cm ID and approximately 0.65 cm wall thickness) bearing a copper foil of approximately 13 μm radial thickness) thereupon (the copper foil was wrapped circumferentially around the outside of the shell and the circumferential ends of the foil were joined to each other with adhesive tape). An inductive heating head and power supply was used of a generally similar type as described above; and, an air knife supplied by house compressed air was used for cooling. Experiments with the alumina/moly setup were able to were able to demonstrate a temperature differential (between the maximum temperature reached by a substrate in passing through the angular heating zone, and the temperature to which the substrate was then cooled by the air nozzle) in the range of e.g. 10° C. or more; experiments with the cardboard/copper setup were able to demonstrate a temperature differential of in the range of e.g. 55° C.

The tests and test results described above are intended solely to be illustrative, rather than predictive, and variations in the testing procedure can be expected to yield different results. All quantitative values in the Examples section are understood to be approximate in view of the commonly known tolerances involved in the procedures used. The foregoing detailed description and examples have been given for clarity of understanding only. No unnecessary limitations are to be understood therefrom.

It will be apparent to those skilled in the art that the specific exemplary structures, features, details, configurations, etc., that are disclosed herein can be modified and/or combined in numerous embodiments. All such variations and combinations are contemplated by the inventor as being within the bounds of the conceived invention not merely those representative designs that were chosen to serve as exemplary illustrations. Thus, the scope of the present invention should not be limited to the specific illustrative structures described herein, but rather extends at least to the structures described by the language of the claims, and the equivalents of those structures. To the extent that there is a conflict or discrepancy between this specification as written and the disclosure in any document incorporated by reference herein, this specification as written will control.

What is claimed is:

1. A device comprising:
a hollow cylindrical roll that is rotatable about an axis of rotation so as to have a rotation path, and that comprises an interior space within the hollow cylindrical roll;
an induction heater that is provided within the interior space of the hollow cylindrical roll and that is positioned radially inwardly adjacent to an angular portion of the rotation path of the hollow cylindrical roll and that is fixedly attached to a heater mount so that the induction heater does not rotate with the hollow cylindrical roll;
wherein the hollow cylindrical roll comprises a hollow cylindrical support shell and an inductively-heatable annular layer that is positioned radially outward of the support shell and is supported thereby and that is in conductive thermal communication with a radially outwardmost surface of the hollow cylindrical roll.

2. The device of claim 1 wherein the inductively-heatable annular layer comprises a radial thickness of from 1 μm to about 500 μm.

3. The device of claim 1 wherein the inductively-heatable annular layer comprises an electrical resistivity of less than about 10⁻⁴ ohm-meter.

4. The device of claim 1 wherein the hollow cylindrical support shell comprises a radial thickness of from about 1 mm to about 4 cm.

5. The device of claim 1 wherein the hollow cylindrical support shell comprises an electrical resistivity of greater than 10⁻⁴ ohm-meter.

6. The device of claim 1 wherein the hollow cylindrical support shell comprises a thermal conductivity of from about 30 to about 0.05 W/m-° K.

7. The device of claim 1 further comprising a surface-cooling device that is positioned radially outward of the hollow cylindrical roll at a location that is rearwardly along the rotation path of the hollow cylindrical roll, which surface-cooling device is configured to direct a moving heat-transfer fluid generally radially inward toward the radially outwardmost surface of the hollow cylindrical roll.

8. A device for thermally processing a substrate, comprising;
a first, hollow cylindrical roll that is rotatable about an axis of rotation so as to have a rotation path, and that defines an interior space within the first roll;
an induction heater that is provided within the interior space of the first roll and that is positioned radially inwardly adjacent to an angular portion of the rotation path of the first roll and that is fixedly attached to a heater mount so that the induction heater does not rotate with the first roll;
wherein the first roll comprises a hollow cylindrical support and an inductively-heatable annular layer that is positioned radially outward of the support shell and is supported thereby and that is in conductive thermal communication with a radially outwardmost surface of the first roll; and,
a second roll that is positioned radially outwardly adjacent the first roll with the first and second rolls being pressed towards each other so as to form a nip therebetween, the nip being provided within the angular portion of the rotation path to which the induction heater is radially adjacent.

9. The device of claim 8 wherein the first roll and the second roll are pressed towards each other to provide a nip pressure of about 2 pounds per linear inch to about 4000 pounds per linear inch.

10. The device of claim 8 wherein the angular portion of the rotation path of the first roll to which the induction heater is positioned radially adjacent, occupies an angular arc along the rotation path of from about 5 degrees to about 45 degrees.

11. The device of claim 8 further comprising a surface-cooling device that is positioned radially outward of the first roll so as to provide a cooling zone at a location that is rearwardly along the rotation path of the first roll from the angular portion of the rotation path of the first roll to which the induction heater is positioned radially adjacent.

12. The device of claim 11 wherein an angular centerpoint of the cooling zone is located from about 25 degrees to about 120 degrees rearwardly along the rotation path of the first roll, from an angular centerpoint of the angular heating zone.

13. The device of claim 11 wherein the surface-cooling device is configured to impinge a moving heat-transfer fluid on the radially outwardmost surface of the first roll or an a major surface of a moving substrate that is in contact with, and moving with, the radially outwardmost surface of the first roll.

14. A method of thermally processing a substrate, the method comprising;
contacting a first major surface of the substrate with a radially outwardmost surface of a hollow cylindrical roll that is rotatable about an axis of rotation so as to have a rotation path, and that defines an interior space within the hollow cylindrical roll,
wherein an induction heater is provided within the interior space of the hollow cylindrical roll and is fixedly attached to a heater mount so that the induction heater does not rotate with the hollow cylindrical roll and is positioned radially inwardly adjacent to an angular portion of the rotation path of the hollow cylindrical roll so as to provide an angular heating zone of the hollow cylindrical roll,
wherein the hollow cylindrical roll comprises a hollow cylindrical support shell and an inductively-heatable layer that is positioned radially outward of the hollow cylindrical support shell and is supported thereby, and that is in conductive thermal communication with the radially outwardmost surface of the hollow cylindrical roll;
operating the induction heater so that the inductively-heatable layer of the hollow cylindrical roll is inductively heated as it passes through the angular heating zone along the rotation path of the hollow cylindrical roll, and,
moving the substrate along the rotation path of the hollow cylindrical roll through the angular heating zone with the substrate in contact with the radially outwardmost surface of the hollow cylindrical roll, so that the substrate is conductively heated by the radially outer surface of the hollow cylindrical roll as the moving substrate passes through the angular heating zone.

15. The method of claim 14, further comprising the step of surface-cooling the substrate by the use of with a surface-cooling device that is positioned radially outward of the first roll so as to provide a cooling zone at a location that is rearwardly along the rotation path of the first roll from the angular heating zone.

16. The method of claim 14 wherein the substrate comprises a solid film.

17. The method of claim 14 wherein the substrate comprises a molten extrudate.

18. The method of claim 14 wherein the inductive heating causes a particular section of the first major surface of the first roll to be heated to a first temperature as the particular section passes through the angular heating zone; and, wherein the surface-cooling causes the particular section to be cooled, as the particular section passes through the cooling zone, to a second temperature that is more than 20° C. below the first temperature.

19. The method of claim 14 wherein the substrate is not significantly inductively heated by the induction heater.

20. The method of claim 14 wherein the hollow cylindrical roll is a first roll and wherein a second roll is provided radially outwardly adjacent the hollow cylindrical first roll with the first and second rolls being pressed towards each other so as to form the nip therebetween, the nip being provided within the angular heating zone of the first roll, and wherein the method comprises moving the substrate into the nip between a first roll and a second roll so as to contact a first major surface of the substrate with the radially outwardmost surface of the first roll and to contact a second major surface of the substrate with a radially outwardmost surface of the second roll.
